(19) United States
(12) Patent Application Publication
(10) Pub. No.: US 2012/0161709 A1
(43) Pub. Date: Jun. 28, 2012

(54) SECONDARY-BATTERY CONTROL APPARATUS

(75) Inventors: Hiroki Fujii, Kariya-shi (JP); Naomi Awano, Nagoya (JP)

(73) Assignee: DENSO CORPORATION, Kariya-city (JP)

(21) Appl. No.: 13/334,520

(22) Filed: Dec. 22, 2011

(30) Foreign Application Priority Data
Dec. 22, 2010 (JP) 2010-286387

(51) Int. Cl. H02J 7/00

(52) U.S. Cl. 320/118

(57) ABSTRACT

In an apparatus for controlling a secondary battery comprised of a plurality of cells connected in series, the apparatus includes a monitor configured to monitor an output voltage of each of the plurality of cells, and determine whether the output voltage of one of the plurality of cells reaches a preset full charge voltage. The apparatus includes a voltage equalizer configured to, when it is determined that the output voltage of one of the plurality of cells reaches the preset full charge voltage, perform a voltage equalizing task to match, with an output voltage of one specified cell in all the cells, the voltages of the remaining cells except for the one specified cell to equalize the output voltages of all the plurality of cells. The output voltage of the specified one cell is the lowest in the output voltages of all the cells.

### CROSS REFERENCE TO RELATED APPLICATIONS

This application is based on Japanese Patent Application 2010-286387 filed on Dec. 22, 2010. This application claims the benefit of priority from the Japanese Patent Application, so that the descriptions of which are all incorporated herein by reference.

### TECHNICAL FIELD

The present disclosure relates to control apparatuses for secondary batteries, and more particularly, to such control apparatuses capable of detecting a residual capacity of such a secondary battery; the residual capacity of a secondary battery shows the residual quantity of energy of the battery.

### BACKGROUND

Secondary batteries, such as lithium ion secondary batteries using Olivine-type lithium phosphate as their cathodes, are each comprised of a plurality of cells connected in series. These secondary batteries are required to detect the SOC (State Of Charge) thereof as a parameter indicative of the remaining capacity thereof with accuracy as high as possible because, if they were overcharged without accurate measurement of their SOC, the lifetime of the secondary batteries would be reduced.

For example, Japanese Patent Application Publication No. 2009-296699 discloses an example in which a secondary battery is used for a photovoltaic power generating system. When the power output of the photovoltaic power generating system based on sunlight is greater than electric power consumption by electrical loads for the photovoltaic power generating system, the photovoltaic power generating system charges the secondary battery with surplus power. In contrast, when the power output of the photovoltaic power generating system based on sunlight is smaller than electric power consumption by the electrical loads, the photovoltaic power generating system drives the loads based on power output from the secondary battery to compensate inadequate power. Because the photovoltaic power generating system set forth above can charge the secondary battery with surplus power, it is possible to enhance energy efficiency as compared with power generating systems without using secondary batteries.

Such a photovoltaic power generating system cannot charge the secondary battery with surplus power after the secondary battery is fully charged, resulting in power loss. In order to prevent the occurrence of power loss, the photovoltaic power generating system detects the residual capacity of the secondary battery with high accuracy, thus preventing the secondary battery from being fully charged.

These secondary batteries can also be used for hybrid systems installed in vehicles (hybrid vehicles). For example, when the output power of the engine of a hybrid vehicle is greater than drive power required for the hybrid vehicle to travel, the hybrid system drives, as a power generator, a motor with surplus engine output, thus charging the secondary battery. In addition, during the hybrid vehicle being braked or decelerated, the hybrid system uses the motor as a power generator to charge the secondary battery.

Load levelling systems effectively using nighttime power and plug-in hybrid vehicles have recently received a great deal of attention. A load levelling system charges power into a secondary battery during nighttime with low electric power consumption and low electric power charge, and uses the charged power during daytime with peak of power consumption. This can level electric power consumption per day to make constant its power output. This can contribute to efficient operation of power equipment and/or reduction in equipment investment.

A plug-in hybrid vehicle is configured to run based on rotational power of a motor driven by electric power supplied from a secondary battery in urban areas, and run based on both rotational power of an engine and that of the motor over long distances.

### SUMMARY

An example of methods of detecting the SOC of a secondary battery uses a no-load voltage (open-circuit voltage) curve VL indicative of a relationship between output voltage of the secondary battery and SOC (%) thereof (see FIG. 1). However, because the output voltage of the secondary battery changes minimally within the range from approximately 3.2 V to approximately 3.4 V when the SOC lies within the range from approximately 10% to approximately 95%, detection of the SOC based on the output voltage of the secondary battery based on the no-load voltage curve VL may reduce the accuracy of the measured SOC.

An alternative example of methods of detecting the SOC of a secondary battery is disclosed in the Patent Publication No. 2009-296699. This method is to stop the charge of a secondary battery, detect a voltage terminal voltage) across both terminals of the secondary battery just after the stop of the charge, and obtain, based on the terminal voltage, voltage-gradient information indicative of the reduction in the terminal voltage per preset time. Because the reduction in the terminal voltage just after the charge has a steep gradient, it is possible to find out correlation between the reduction in the terminal voltage per preset time and the SOC. This enables detection of the SOC with a high degree of accuracy.

However, the method disclosed in the Patent Publication No. 2009-296699 requires the stop of the charge of a secondary battery in detecting the SOC of the secondary battery. This may deteriorate the usability of electric loads requiring electric power of the secondary battery.

Thus, in order to detect the SOC of a secondary battery during the secondary battery being charged or discharged, there is a method of integrating charge current to a secondary battery or discharge current therefrom with a current detection sensor, and compare the integrated value with a corresponding charge-current or discharge-current integrated value of the secondary battery being fully charged, thus detecting the SOC of the secondary battery based on a result of the comparison.

However, because measured values of each of charge current and discharge current by the current detection sensor include measurement errors, the difference between the measured integrated values of charge current or discharge current and actual integrated values thereof increases with time. This may result in an increase in the difference between a measured value of the SOC of the secondary battery based on the measured integrated values and an actual value of the SOC of the secondary battery, thus reducing the accuracy of the measured values of the SOC.

In addition, because a secondary battery is comprised of a plurality of cells connected in series, even if it is detected that a cell is fully charged because the SOC thereof becomes 100% (maximum value), the SOC of another cell may not be other than 100%, such as 99% and 98%, resulting in variations in SOC among the plurality of cells. The variations may make it difficult to use, even if it is detected that a cell is fully charged because the SOC thereof becomes 100%, 100% of the capacity of an alternative cell with the SOC other than 100%, such as 99% and 98%. This may result in reduction in a total chargeable capacity of the secondary battery.

In view of the circumstances set forth above, one aspect of the present disclosure seeks to provide secondary-battery control apparatuses designed to address at least one of the problems set forth above.

Specifically, an alternative aspect of the present disclosure aims to provide such control apparatuses capable of preventing the reduction in a total chargeable capacity of a secondary battery. A further aspect of the present disclosure aims to detect a residual capacity of a secondary battery at a preset timing while the secondary battery is charged or discharged.

According to a first exemplary aspect of the present disclosure, there is provided an apparatus for controlling a secondary battery comprised of a plurality of cells connected in series. The apparatus includes a monitor configured to monitor an output voltage of each of the plurality of cells, and determine whether the output voltage of one of the plurality of cells reaches a preset full charge voltage. The apparatus includes a voltage equalizer configured to, when it is determined that the output voltage of one of the plurality of cells reaches the preset full charge voltage, perform a voltage equalizing task to match, with an output voltage of one specified cell in all the cells, the voltages of the remaining cells except for the one specified cell to equalize the output voltages of all the plurality of cells. The output voltage of the specified one cell is the lowest in the output voltages of all the cells.

According to the first exemplary aspect of the present disclosure, when one of the plurality of cells reaches the preset full charge voltage, the voltage equalizer performs the voltage equalizing task to match, with an output voltage of one specified cell in all the cells, the voltages of the remaining cells except for the one specified cell to equalize the output voltages of all the plurality of cells. The output voltage of the specified one cell is the lowest in the output voltages of all the cells.

That is, because all the cells are connected in series, equalization of the output voltages of all the cells allows the characteristics of all the cells to be identical to each other. Thus, charge and/or discharge for the secondary battery after the equalization allows the cells to be identically charged and/or discharged. This results in that all the cells are fully charged with their residual capacities being their full values at substantially identical timing.

In contrast, conventional charge and discharge control for a secondary battery comprised of series-connected cells without performing such a voltage equalization task may cause variations in the output voltages of the series-connected cells when the output voltage of one of the cells becomes a full charge voltage; the variations are that the output voltages of the other cells are lower than the full charge voltage of the one of the cells. The variations in the output voltages of the series-connected cells result from the difference in the internal resistances of the respective cells.

Specifically, the output voltage of each cell includes a voltage component (an internal voltage) appearing across a corresponding cell when current flows therethrough, and the internal voltages of the respective cells are different from each other because the internal resistances of the respective cells are different from each other. Thus, there are variations in the output voltages of the series-connected cells due to the difference in the internal voltages of the respective cells.

These voltage variations may cause each of the other cells not to use a preset full value (100%) of its useable capacity, resulting in reduction in a total chargeable capacity of the secondary battery.

However, as described above, the apparatus according to the exemplary aspect of the present disclosure makes it possible to substantially eliminate variations in the output voltages of the cells, thus using a preset full value of the usable capacity of each of the cells. This prevents reduction in the total chargeable capacity of the secondary battery.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be constructed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is graph schematically illustrating a relationship between output voltage of a secondary battery and SOC (%) thereof;

FIG. 2 is a block diagram schematically illustrating an example of the overall structure of a battery system using a charge control apparatus according to an embodiment of the present disclosure for a lithium ion secondary battery as an example of secondary batteries; and

FIG. 3 is a flowchart schematically illustrating a charge and/or discharge task for a secondary battery in the battery system illustrated in FIG. 2.

### DETAILED DESCRIPTION OF EMBODIMENT

An embodiment of the present disclosure will be described hereinafter with reference to the accompanying drawings. In the drawings, identical reference characters are utilized to identify identical corresponding components.

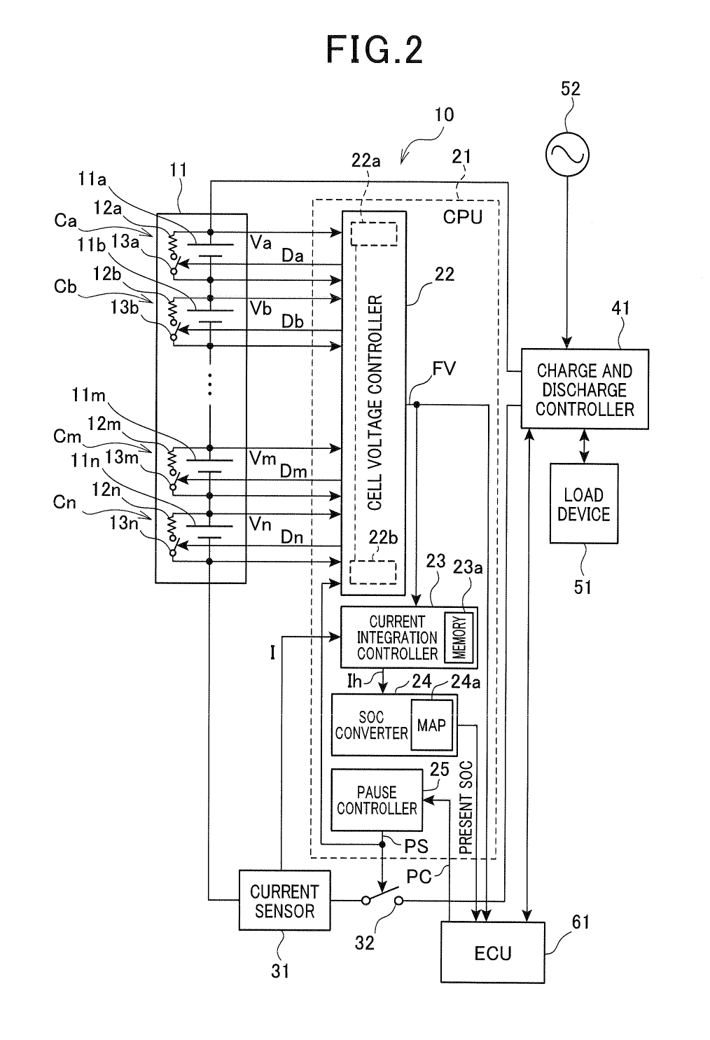

Referring to the drawings, particularly to FIG. 2, there is illustrated a battery system 10 including a secondary battery control apparatus according to this embodiment.

The battery system 10 includes a lithium ion secondary battery 11 as a battery pack, which is an example of secondary batteries; the lithium ion secondary battery 11 will be referred to simply as a secondary battery.

The secondary battery 11 is comprised of a plurality of cells 11a, 11b, . . . , 11m, and 11n connected in series, and a plurality of resistor circuits Ca, Cb, . . . , Cm, and Cn connected between the positive and negative electrodes of the cells 11a, . . . , 11n, respectively. Each of the resistor circuits Ca, Cb, . . . , Cm, and Cn is comprised of a corresponding resistor 12a, 12b, . . . , 12m, or 12n and a corresponding on-off switch 13a, 13b, . . . , 13m, or 13n connected in series. For example, the resistor circuit Ca is comprised of the resistor 12a and the switch 12b connected in series.

The positive electrode of each of the cells 11a to 11n is composed of an olivine lithium-metal-phosphate material.

The battery system 10 also includes a CPU (Central Processing Unit) 21 as an example of charge control apparatuses for the secondary battery 11. The battery system 10 further includes a current sensor 31, an on-off switch 32, and a charge and discharge controller 41.

The current sensor 31 has one end connected with, for example, the negative electrode of the cell 11n and the resistor circuit Cn as a negative end of the secondary battery 11, and has the other end connected with the on-off switch 32. The current sensor 31 also has a control terminal connected with the CPU 21. The current sensor 31 is operative to measure a charge current into the secondary battery 11 or a discharge current therefrom as a charge and discharge current I, and output the measured charge and discharge current I to the CPU 21. The on-off switch 32 is connected between the current sensor 31 and the charge and discharge controller 41. The on-off switch 32 has a control terminal with which the CPU 21 is connected.

The charge and discharge controller 41 is connected with, for example, the positive electrode of the cell 11a and the resistor circuit Ca as a positive end of the secondary battery 11, and connected with the negative electrode of the cell 11n and the resistor circuit Cn as the negative end of the secondary battery 11 via the current sensor 31 and the on-off switch 32. The charge and discharge controller 41 is also connected with an electrical load device 51. The charge and discharge controller 41 is a plug-in system removably connected at its plug with a receptacle of a commercial power source 52.

The CPU 21 is connected with both ends of each of the cells 11a, . . . , 11n, each of the on-off switches 13a, . . . , 13n, and an ECU 61.

Note that the battery system 10 according to this embodiment is installed in a plug-in hybrid vehicle, so that the ECU 61 is an electronic control unit for overall control of the plug-in hybrid vehicle, and the load device 51 is a hybrid motor for vehicles. If the battery system 10 is used as a power source of another object, the load device 51 is a device, such as an air conditioner for domestic use or commercial use, which consumes electrical power loads.

The hybrid motor as the load device 51 is operative to perform, in a first operation mode, given operations, such as output torque, according to electric power supplied from the secondary battery 11 via the charge and discharge controller 41, and output, in a second operation mode (a power generation mode), electric power.

The charge and discharge controller 41, which serves as, for example, a charge and discharge unit, is operative to supply electric power from the secondary battery 11 to the load device 51 in response to discharge instructions, and output, to the secondary battery 11, electric power from the commercial power source 52 and/or the load device 51 to charge the secondary battery 11.

The CPU 21 functionally comprises a cell voltage controller 22, a current integration controller 23, an SOC converter 24, and a pause controller 25.

The cell voltage controller 22, which, for example, serves as a monitor 22a, is operative to monitor output voltages (terminal voltages) Va to Vn of the respective cells 11a to 11n across both positive and negative electrodes thereof, and detect that the highest voltage in the output voltages Va to Vn reaches a predetermined full charge voltage of, for example, 3.6 V; this full charge voltage represents that a corresponding cell is fully charged. The cell voltage controller 22 is also operative to output, to each of the ECU 61 and the current integration controller 23, a full-charge detection signal FV in response to the detection of full charge of a corresponding cell.

The pause controller 25 is operative to output a pause control signal PS to each of the on-off switch 32 via the control terminal and the cell voltage controller 22 when receiving a charge pause instruction PC from the ECU 61; the charge pause instruction PC is supplied from the ECU 61 in response to receipt of the full-charge detection signal FV. The pause control signal PS causes the on-off switch 32 to be turned off, resulting in a pause of charge to the secondary battery 11 and discharge therefrom.

When the pause control signal PS is inputted to the cell voltage controller 22, the cell voltage controller 22, which, for example, serves as a voltage equalizer 22b, detects the output voltages (terminal voltages) Va to Vn of the respective cells 11a to 11n, and performs an equalizing task to equalize the terminal voltages of all the cells 11a to 11n. In this embodiment, the equalizing task is to extract at least one cell with the terminal voltage being the lowest in level in the terminal voltages of all the cells 11a to 11n, and match, with the lowest terminal voltage of the at least one cell, the terminal voltages of the other cells (referred to as higher-side cells), thus equalizing the terminal voltages of all the cells 11a to 11n.

Specifically, assuming that the cell 11a is the cell with the lowest terminal voltage, and the cells 11b to 11n are the higher-side cells, the equalizing task is designed to output discharge signals Db to Dn to the on-off switches 13b to 13n corresponding to the higher-side cells 11b to 11n to turn on the on-off switches 13b to 13n. This allows charged energy in the higher-side cells 11b to 11n to be discharged via the corresponding resistors 12b to 12n, so that the terminal voltages Vb to Vn of the higher-side cells 11b to 11n are matched with the lowest terminal voltage Va of the cell 11a. This results in equalization of the terminal voltages Va to Vn of all the cells 11a to 11n.

As described above, the cell voltage controller 25 is configured to perform the equalizing task with charge to the secondary battery 11 and discharge therefrom being paused. This aims to prevent level shift of the terminal voltages Va to Vn of the respective cells 11a to 11n during the secondary battery 11 being charged; this level shift will be described later.

The current integration controller 23 is comprised of a memory 23a; this memory 23a is, for example, an internal memory of the CPU 21. The current integration controller 23 is operative to integrate the charge and discharge current I measured by the current sensor 31 over time (hours), and output an integral Ih to the SOC converter 24 while storing the integral Ih in the memory 23a so as to overwrite an old value of the integral Ih stored in the memory 23a into a new value of the integral Ih.

The current integration controller 23 is also operative to, when the full-charge detection signal FV is inputted thereto from the cell voltage controller 22, correct a present value of the integral Ih stored in the memory 23a at the input timing of the full-charge detection signal FV to a predetermined full-charge integral Ihf, and overwrite the old value of the integral Ih stored in the memory 23a into the full-charge integral Ihf, thus outputting, to the SOC converter 24, the full-charge integral Ihf.

The SOC converter 24 is comprised of a map 24a in data-table format, in mathematical expression format, and/or program format. The map 24a represents a relationship (function) between integral Ih and SOC of the secondary battery 11. For example, the relationship shows a linear relationship between integral Ih and SOC of the secondary battery 11. Specifically, the liner relationship is that, when the present integrated value Ih is the full-charge integral Ihf, the SOC becomes 100% (maximum value), and, thereafter, the integral Ih is reduced at a preset rate with the SOC being reduced at the same rate, so that, when a present value of the integral Ih reaches 0 Ah, the SOC reaches 0%.

Note that the SOC is a parameter indicative of the remaining capacity (residual capacity) of a secondary battery.

When the present value of the integral Ih is inputted to the SOC converter 24, the SOC converter 24 converts the present value of the integral Ih into a corresponding present value of the SOC (%) in accordance with the map 24a, and outputs the present SOC (%) to the ECU 61. When the full-charge integral Ihf is inputted to the SOC converter 24, the SOC converter 24 converts the present SOC (%) to 100% (maximum value) of the SOC, and outputs 100% of the SOC (%) to the ECU 61.

Note that the current integration controller 23 is adapted to correct measurement errors at the current sensor 31. Specifically, because there are errors in the measured charge and discharge current I, when the measured charge and discharge current I including measurement errors is integrated over time by the current integration controller 23, the present value of the integral Ih may be an incorrect value, so that, when the incorrect value of the integral Ih is converted into a present value of the SOC by the SOC converter 24, the present value of the SOC may be an incorrect value.

For example, it is assumed that the present value of the integral Ih at the current integration controller 23 is 9.5 Ah with its value being deviated, due to a measurement error at the current sensor 31, from a real value of 10 Ah corresponding to the full-charge integral Ihf. In this assumption, if, as the present value of the integral, the full-charge integral of 10 Ah were inputted to the SOC converter 24 without any measurement errors at the current sensor 31, it would be converted into 100% of the SOC. However, because 9.5 Ah of the present value of the integral is actually inputted to the SOC converter 24, it is converted into, for example, 95% of the SOC.

Thus, in order to address such a situation, the current integration controller 23 is also operative to, when the full-charge detection signal FV is inputted thereto from the cell voltage controller 22, correct the present value of the integral Ih of, for example, 9.0 Ah at the input timing of the full-charge detection signal FV to the full-charge integral Ihf of 10 Ah.

The ECU 61 is programmed to, when the plug of the charge and discharge controller 41 is connected with a receptacle of the commercial power source 52, output a charge instruction to the charge and discharge controller 41 if the present value of the SOC inputted from the SOC converter 24 is lower than 100%; the charge instruction instructs the charge and discharge controller 41 to output electric power supplied from the commercial power source 52 to the secondary battery 11.

The ECU 61 is also programmed to, when the plug-in hybrid vehicle becomes a preset running state with the charge and discharge controller 41 being disconnected with the commercial power source 52, output a charge instruction to the charge and discharge controller 41 if the present value of the SOC inputted from the SOC converter 24 is lower than 100%; the charge instruction instructs the charge and discharge controller 41 to output electric power generated from the hybrid motor of the load device 51 to the secondary battery 11.

The ECU 61 is further programmed to output a charge stop instruction to the charge and discharge controller 41 when the preset value of the SOC is 100%; the charge stop instruction instructs the charge and discharge controller 41 to prevent electric power from the commercial power source 52 or the load device 51 from being outputted to the secondary battery 11. The ECU 61 is still further programmed to output a discharge instruction to the charge and discharge controller 41; the discharge instruction instructs the charge and discharge controller 41 to output electric power from the secondary battery 11 to the hybrid motor of the load device 51.

Note that, in this embodiment, the resistor circuits Ca to Cn, the CPU 21, the current sensor 31, the on-off switch 32, the charge and discharge controller 41, and the ECU 61 constitute the secondary-battery control apparatus.

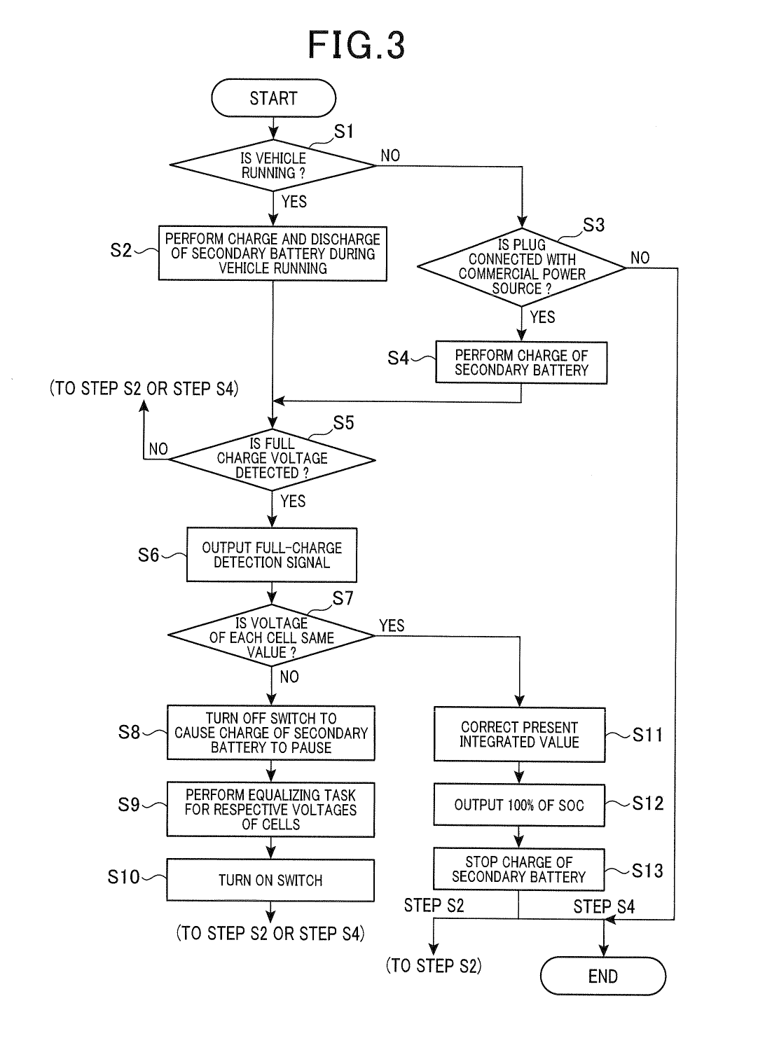

Next, a charge and/or discharge task for the secondary battery 11 in the battery system 10 will be described hereinafter with reference to a flowchart illustrated in FIG. 3. Note that the full-charge integral Ihf to be used by the current integration controller 23 for correction is set to 10 Ah, and the map 24a represents a liner relationship between integral Ih and SOC of the secondary battery 11 such that, when the present value of the integral Ih is the full-charge integral Ihf of 10 Ah, the SOC becomes 100%. The charge and/or discharge task is repeated every preset cycle after power-on of the battery system 10.

In step S1, the CPU 21 or the ECU 61 of the battery system 10 determines whether the plug-in hybrid vehicle is running in step S1. When determining that the plug-in hybrid vehicle is running (YES in step S1), the battery system 10 operates in running mode to cooperatively perform charge and discharge operations for the secondary battery 11 during the plug-in vehicle running in step S2.

For example, in step S2, the ECU 61 outputs a charge instruction or the discharge instruction to the charge and discharge controller 41 according to the present value of the SOC inputted from the SOC converter 24 with the charge and discharge controller 41 being disconnected with the commercial power source 52. For example, when the hybrid motor of the load device 51 is generating electric power with the present value of the SOC is 70%, the ECU 61 outputs the charge instruction to the charge and discharge controller 41 to instruct the charge and discharge controller 41 to output electric power generated from the hybrid motor of the load device 51 to the secondary battery 11. This charges the secondary battery 11.

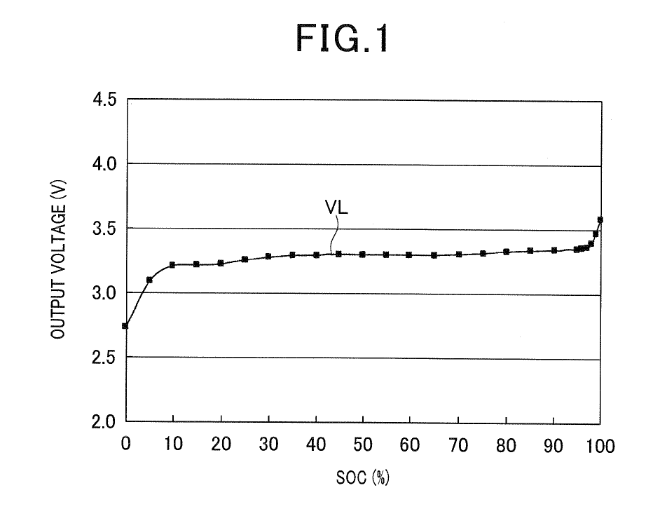

Particularly, for running the plug-in vehicle by the hybrid motor of the load device 51, when need arises, the ECU 61 outputs the discharge instruction to the charge and discharge controller 41 to instruct the charge and discharge controller 41 to output electric power from the secondary battery 11 to the hybrid motor of the load device 51. These charge control and discharge control allow the secondary battery 11 to be charged and discharged, so that the SOC is increased and reduced as illustrated in, for example, FIG. 1.

Otherwise, when determining that the plug-in hybrid vehicle is not running (NO in step S1), the CPU 21 or the ECU 61 determines whether the plug of the charge and discharge controller 41 is inserted into a receptacle of the commercial power source 52 with the plug-in vehicle being parked during, for example, nighttime in step S3. When determining that the plug of the charge and discharge controller 41 is not inserted into a receptacle of the commercial power source 52 (NO in step S3), the CPU 21 or the ECU 61 terminates the charge and/or discharge task.

Otherwise, when determining that the plug of the charge and discharge controller 41 is inserted into a receptacle of the commercial power source 52 with the plug-in vehicle being parked during, for example, nighttime, so that the charge and discharge controller 41 is electrically connected with the commercial power source 52 (YES in step S3), the battery system 10 operates in plug-in charge mode, and the ECU 61 outputs a charge instruction to the charge and discharge controller 41 while the present value of the SOC is lower than 100%. The charge instruction instructs the charge and discharge controller 41 to supply electric power from the commercial power source 52 to the secondary battery 11, so that the secondary battery 11 is charged in step S4.

During the CPU 21 and the ECU 61 cooperatively perform the operation in step S2 or step S4, the cell voltage controller 22 determines whether the highest voltage in the monitored output voltages Va to Vn of the respective cells 11a to 11n reaches the predetermined full charge voltage of 3.6 V by the operation in step S2 or S4 set forth above in step S5.

When the highest voltage in the monitored output voltages Va to Vn of the respective cells 11a to 11n does not reach the predetermined full charge voltage of 3.6 V (NO in step S5), the cell voltage controller 22 repeats the operation in step S2 or S4 and the determination in step S5 in accordance with the present operation mode of the battery system 10.

Otherwise, when the highest voltage in the monitored output voltages Va to Vn of the respective cells 11a to 11n, such as the output voltage Va across the cell 11a, reaches the predetermined full charge voltage of 3.6 V (YES in step S5), the cell voltage controller 22 outputs, to each of the ECU 61 and the current integration controller 23, the full-charge detection signal FV in step S6 (see FIG. 1).

When receiving the full-charge detection signal FV, the ECU 61 determines whether the terminal voltages of the respective cells 11a to 11n are identical to each other in step S7.

When determining that the terminal voltages of the respective cells 11a to 11n are not identical to each other (NO in step S7), the ECU 61 outputs, to the pause controller 25, the charge pause instruction PC; the charge pause instruction PC instructs the pause controller 25 to output the pause control signal PS to each of the on-off switch 32 and the cell voltage controller 22 in step S8. The pause control signal PS causes the on-off switch 32 to be turned off so that the charge and discharge route between the charge and discharge controller 41 and the secondary battery 11, resulting in a pause of charge to the secondary battery 11 and discharge therefrom in step S8.

Next, in response to detection of the pause control signal PS, the cell voltage controller 22 detects the output voltages (terminal voltages) Va to Vn of the respective cells 11a to 11n with a pause of charge to the secondary battery 11 and discharge therefrom, and performs the equalizing task to equalize the terminal voltages of all the cells 11a to 11n in step S9.

Specifically, in step S9, the cell voltage controller 22 extracts at least one cell with the terminal voltage being the lowest in level in the terminal voltages of all the cells 11a to 11n. For example, in this embodiment, the cell voltage controller 22 extracts the cell 11a with the terminal voltage of 3.4 V being lower than the terminal voltages of any other cells 11a to 11m; the terminal voltages of any other cells 11a to 11m are within the range from 3.5 V to 3.6 V inclusive. Then, the cell voltage controller 22 matches, with the lowest terminal voltage (for example, 3.4 V) of the at least one cell (for example, the cell 11n), the terminal voltages of the other cells (higher-side cells), thus equalizing the terminal voltages of all the cells 11a to 11n to the lowest voltage of, for example, 3.4 V.

Specifically, assuming that the cell 11n is the cell with the lowest terminal voltage of 3.4 V and the cells 11a to 11m are the higher-side cells set forth above, the equalizing task is designed to output, from the cell voltage controller 22, the discharge signals Da to Dm to the on-off switches 13a to 13m corresponding to the higher-side cells 11a to 11m to turn on the on-off switches 13a to 13m. This allows charged energy in the higher-side cells 11a to 11m to be discharged via the corresponding resistors 12a to 12m, so that the terminal voltages Va to Vm of the higher-side cells 11a to 11m are matched with the lowest terminal voltage Vn of the cell 11n. This results in equalization of the terminal voltages Va to Vn of all the cells 11a to 11n to 3.4 V.

After completion of the equalization in step S9, the pause controller 25 turns off the on-off switch 32 in step S10. Then, the CPU 21 and the ECU 61 return to the corresponding operation in step S2 or step S4, thus repeating the operations in steps S2 and S5 to S10 or the operations in steps S4 to S9 according to the present operation mode of the battery system 10.

On the other hand, when the terminal voltages of the respective cells 11a to 11n are identical to each other (YES in step S7), the ECU 61 outputs the full-charge detection signal FV to the current integration controller 23 in step S11. When receiving the full-charge detection signal FV, the current integration controller 23 corrects the present value of the integral Ih of for example, 9.5 Ah presently stored in the memory 23a to the preset full-charge integral Ihf of, for example, 10 Ah by updating it thereto in step S11.

Next, in step S12, the current integration controller 23 outputs, to the SOC converter 24, the full-charge integral Ihf, so that 100% of the SOC corresponding to the full-charge integral Ihf is outputted to the ECU 61. Then, the ECU 61 outputs, to the charge and discharge controller 41, the charge stop instruction in step S13. In response to the charge stop instruction, the charge and discharge controller 41 prevents electric power from the commercial power source 52 or the load device 51 from being outputted to the secondary battery 11 in step S13.

After completion of the operation in step S13, the CPU 21 and the ECU 61 return to the corresponding operation in step S2, thus repeating the operations in steps S2 and S5 to S13 when the battery system 10 operates in the running mode, or terminates the charge and/or discharge task when the battery system 10 operates in the plug-in charge mode.

Note that, in step S13, the ECU 61 can output, to the pause controller 25, an instruction to turn on the on-off switch 32 while outputting the charge stop instruction to the charge and discharge controller 41, thus turning on the on-off switch 32 by the charge and discharge controller 41. This can prevent the secondary battery 11 being charged irrespective of the on-state of the on-off switch 32.

The battery system 10 according to this embodiment is installed in the plug-in hybrid vehicle, so that the charge and discharge task can be cooperatively performed by the CPU 21 and the ECU 61. However, the charge and discharge task can be performed by the CPU 21. Particularly, when the battery system 10 is used as a power source of another object, so that the load device 51 is a device, such as an air conditioner for domestic use or commercial use, which consumes electrical power loads, the charge and discharge task can be preferably performed by the CPU 21.

In this modification, in step S7, the CPU 21 determines whether the terminal voltages of the respective cells 11a to 11n are identical to each other in step S7.

When determining that the terminal voltages of the respective cells 11a to 11n are not identical to each other (NO in step S7), the CPU 21 serves as the pause controller 25 to output the pause control signal PS to the on-off switch 32, thus causing the on-off switch 32 to be turned off in step S8. Next, in step S9, the CPU 21 serves as the cell voltage controller 22 to detect the output voltages (terminal voltages) Va to Vn of the respective cells 11a to 11n with a pause of charge to the secondary battery 11 and discharge therefrom, and performs the equalizing task to equalize the terminal voltages of all the cells 11a to 11n.

In modification, in step S2, when need arises, the CPU 21 serves as the charge and discharge controller 41 to output electric power from the secondary battery 11 to the hybrid motor of the load device 51.

In this modification, in step S4, the CPU 21 serves as the charge and discharge controller 41 to supply electric power from the commercial power source 52 to the secondary battery 11 while the present value of the SOC is lower than 100%, thus charging the secondary battery 11.

In this modification, in step S12, when 100% of the SOC corresponding to the full-charge integral Ihf is outputted, the CPU 21 serves as the charge and discharge controller 41 to prevent electric power from the commercial power source 52 or the load device 51 from being outputted to the secondary battery 11 in step S13.

As described above, the secondary-battery control apparatus according to this embodiment is adapted to control the secondary battery 11 comprised of the cells 11a to 11n connected in series. The secondary-battery control apparatus is characterized in that, when one of the cells 11a to 11n, for example, the cell 11a, becomes fully charged, the cell voltage controller 22 performs the equalizing task to extract at least one cell, for example, the cell 11n, with the terminal voltage being the lowest in level in the terminal voltages of all the cells 11a to 11n, and match, with the lowest terminal voltage (Vn) of the at least one cell (11n), the terminal voltages (Va to Vm) of the other cells (higher-side cells 11a to 11m), thus equalizing the terminal voltages of all the cells 11a to 11n.

That is, because all the cells 11a to 11n are connected in series, equalization of the terminal voltages Va to Vn of all the cells 11a to 11n allows the characteristics of all the cells 11a to 11b to be identical to each other. Thus, charge and/or discharge for the secondary battery 11 after the equalization allows the cells 11a to 11n to be identically charged and/or discharged. This results in that all the cells 11a to 11n are fully charged with their SOCs being 100% at substantially identical timing.

In contrast, conventional charge and discharge control for a secondary battery comprised of series-connected cells without performing such equalization may cause variations in the terminal voltages of the series-connected cells when the terminal voltage of one of the cells becomes a full charge voltage; the variations are that the terminal voltages of the other cells are lower than the full charge voltage of the one of the cells. The variations in the terminal voltages of the series-connected cells result from the difference in the internal resistances of the respective cells.

Specifically, the terminal voltage of each cell includes a voltage component (an internal voltage) appearing across a corresponding cell when current flows therethrough, and the internal voltages of the respective cells are different from each other because the internal resistances of the respective cells are different from each other. Thus, there are variations in the terminal voltages of the series-connected cells due to the difference in the internal voltages of the respective cells.

These voltage variations may cause each of the other cells not to use 100% of its useable capacity, resulting in reduction in a total chargeable capacity of the secondary battery.

However, as described above, the secondary-battery control apparatus according to this embodiment makes it possible to substantially eliminate variations in the terminal voltages of the cells 11a to 11n, thus using 100% of the usable capacity of each of the cells 11a to 11n. This prevents reduction in the total chargeable capacity of the secondary battery 11.

In addition, the secondary-battery control apparatus according to this embodiment is comprised of an on-off switch 32 provided on a charge and discharge path between the secondary battery 11 and the load device 51; the switch 32 is operative to open or close to shut down or electrically continue the charge and discharge line. The cell voltage controller 22 turns off the on-off switch 32 to shut down the charge and discharge line, and thereafter, performs the equalizing task set forth above.

The shutdown of the charge and discharge line results in a pause of charge and discharge for the secondary battery 11.

Specifically, as described above, the terminal voltage of each cell includes an internal voltage appearing across a corresponding cell when current flows therethrough, and the internal voltages of the respective cells 11a to 11n are different from each other because the internal resistances of the respective cells 11a to 11n are different from each other. Thus, there are variations in the terminal voltages of the series-connected cells 11a to 11n due to the difference in the internal voltages of the respective cells 11a to 11n.

However, as described above, the secondary-battery control apparatus according to this embodiment performs the equalizing task with a pause of charge and discharge for the secondary battery 11. This prevents the internal voltage from appearing across each of the cells 11a to 11n, so that there are no deviations between the terminal voltages of the respective cells 11a to 11n. This makes it possible to detect the terminal voltages of the cells 11a to 11n in proper state.

The secondary-battery control apparatus according to this embodiment is comprised of the plurality of resistor cells Ca to Cn connected between the positive and negative electrodes of the cells 11a to 11n, respectively; each of the resistor circuits Ca to Cn is comprised of a corresponding one of the resistors 12a to 12n and a corresponding one of the on-off switches 13a to 13n connected in series.

The secondary-battery control apparatus is configured such that, assuming that the cell 11n is the cell with the lowest terminal voltage and the cells 11a to 11m are the higher-side cells, the cell voltage controller 22 turns on the on-off switches 13a to 13m corresponding to the high-side cells 11a to 11m to discharge charged energy in the higher-side cells 11a to 11m via the corresponding resistors 12a to 12m. This matches the terminal voltages Va to Vm of the higher-side cells 11a to 11m with the lowest terminal voltage Vn of the cell 11n, resulting in equalization of the terminal voltages Va to Vn of all the cells 11a to 11n.

The secondary-battery control apparatus according to this embodiment is comprised of the current sensor 31, the current integration controller 23, and the SOC converter 24. The current sensor 31 serves as, for example, a current measuring means operative to measure a charge current into the secondary battery 11 or a discharge current therefrom as a charge and discharge current I. The current integration controller 23 serves as, for example, a current integrator operative to integrate the charge and discharge current I measured by the current sensor 31 over time (hours), and output an integral Ih of the charge and discharge current I to the SOC converter 24 while storing the integral Ih in the memory 23a so as to overwrite the old value of the integral Ih stored in the memory 23a into the new value of the integral Ih.

The current integration controller 23 is also operative to, when a full charge voltage of one cell is detected by the cell voltage controller 22, correct a present value of the integral Ih at the detection timing to the predetermined full-charge integral Ihf, and overwrite the old value of the integral Ih stored in the memory 23a into the full-charge integral Ihf, thus outputting, to the SOC converter 24, the full-charge integral Ihf.

The SOC converter 24 serves as, for example a converter operative to:

convert the present value of the integral Ih inputted from the current integration controller 23, to a corresponding present value of the SOC (%), which is equivalent to a present value of the residual capacity of the secondary battery 11; and

when the full-charge integral Ihf is inputted to the SOC converter 24, convert the present value of the residual capacity of the secondary battery 11 to 100% of the residual capacity thereof.

With the configuration of the secondary-battery control apparatus according to this embodiment, it is possible for the current integration controller 23 to properly correct measurement errors at the current sensor 31. Specifically, because there are errors in the measured charge and discharge current I, when the measured charge and discharge current I including measurement errors is integrated over time by the current integration controller 23, the present value of the integral Ih may be an incorrect value, so that, when the incorrect value of the integral Ih is converted into a present value of the SOC (residual capacity) by the SOC converter 24, the present value of the SOC may be an incorrect value.

For example, it is assumed that the present value of the integral Ih at the current integration controller 23 is 9.5 Ah with its value being deviated, due to a measurement error at the current sensor 31, from a real value of 10 Ah corresponding to the full-charge integral Ihf. In this assumption, if, as the present integrated value, the full-charge integral of 10 Ah were inputted to the SOC converter 24 without any measurement errors at the current sensor 31, it would be converted into 100% of the SOC. However, because 9.5 Ah of the present value of the integral is actually inputted to the SOC converter 24, it is converted into, for example, 95% of the SOC.

Thus, in order to address such a situation, the current integration controller 23 is operative to, when the full charge voltage of one cell is detected, correct the present value of the integral Ih of, for example, 9.0 Ah at the input timing of the full-charge detection signal FV to the full-charge integral Ihf of 10 Ah. This achieves a proper value of the SOC at the preset timing when the full charge voltage of one cell is detected.

In the embodiment, each of the cells 11a to 11n of the secondary battery 11 is configured such that the positive electrode is composed of an olivine lithium-metal-phosphate material, but the present disclosure is not limited to the configuration. Specifically, the present disclosure can be preferably applied to secondary batteries comprised of series-connected cells; the output voltage of each cell can widely vary depending on a value of the SOC (residual capacity) of the secondary battery when a corresponding cell reaches a preset full charge voltage or thereabout. The present disclosure can be however applied to another type of secondary batteries comprised of series-connected cells.

While the illustrative embodiment and its modifications of the present disclosure have been described herein, the present disclosure is not limited to the embodiment and its modifications described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be constructed as non-exclusive.

What is claimed is:

1. An apparatus for controlling a secondary battery comprised of a plurality of cells connected in series, the apparatus comprising:
a monitor configured to monitor an output voltage of each of the plurality of cells, and determine whether the output voltage of one of the plurality of cells reaches a preset full charge voltage; and
a voltage equalizer configured to, when it is determined that the output voltage of one of the plurality of cells reaches the preset full charge voltage, perform a voltage equalizing task to match, with an output voltage of one specified cell in all the cells, the voltages of the remaining cells except for the one specified cell to equalize the output voltages of all the plurality of cells, the output voltage of the specified one cell being the lowest in the output voltages of all the cells.

2. The apparatus according to claim 1, wherein the secondary battery is connected with a load device to be selectively chargeable and dischargeable via a line, and the voltage equalizer comprises:
an on-off switch provided on the line,
the voltage equalizer is configured to turn off the on-off switch to shut down the line, and thereafter, perform the voltage equalizing task.

3. The apparatus according to claim 2, wherein the voltage equalizer comprises:
a plurality of resistor circuits connected between positive and negative electrodes of the plurality of cells, respectively, each of the plurality of resistor circuits comprising a resistor and an on-off switch connected in series,
the voltage equalizer being configured to turn on the switches of the remaining cells except for the one specified cell to discharge charged energy from the remaining cells, thus matching, with the output voltage of the one specified cell in all the cells, the voltages of the remaining cells except for the one specified cell.

4. The apparatus according to claim 1, further comprising:
a current sensor configured to measure one of a charge current into the secondary battery and a discharge current therefrom as a charge and discharge current;
a current integrator having a memory and configured to:
integrate the charge and discharge current measured by the current sensor over time;
output an integral of the charge and discharge current while storing the integral in the memory; and
when it is determined that the output voltage of one of the plurality of cells reaches the preset full charge voltage, replace a present value of the integral of the charge and discharge current stored in the memory at the determination timing with a preset full-charge integral in the memory; and
a converter configured to:
convert the integral of the charge and discharge current outputted from the current integrator into a residual capacity of the second battery; and
convert a present value of the residual capacity of the second battery to a predetermined maximum value of the residual capacity in response to when the present value of the integral of the charge and discharge current is replaced with the full-charge integral in the memory.

5. The apparatus according to claim 1, wherein the voltage equalizer is configured to:
determine whether the output voltages of the respective cells are identical to each other, and
when it is determined that the output voltages of the respective cells are not identical to each other, perform the voltage equalizing task.

6. The apparatus according to claim 2, further comprising:
a charge and discharge unit configured to perform charge and discharge operations to supply electric power from the secondary battery to the load device via the line, and output, to the secondary battery, electric power supplied from the load device via the line.

7. The apparatus according to claim 6, wherein the voltage equalizer is configured to turn on the on-off switch after execution of the equalizing task to electrically continue the line.

8. The apparatus according to claim 6, wherein the charge and discharge unit is removably connected with a commercial power source, and configured to perform charge operations to output, to the secondary battery, electric power supplied from the commercial power source.
